(19) United States
(12) Patent Application Publication
(10) Pub. No.: US 2026/0206073 A1
(43) Pub. Date: Jul. 16, 2026

(54) SELF ESTABLISHMENT AND MANAGEMENT OF D2 INTERFACE BETWEEN NEIGHBOR OPEN DISTRIBUTED UNITS (O-DUS) FOR CARRIER AGGREGATION

(71) Applicant: DISH Wireless L.L.C., Englewood, CO (US)

(72) Inventors: Daejoong Kim, Seoul (KR); Khalid Al-Mufti, Sterling, VA (US)

(21) Appl. No.: 19/022,979

(22) Filed: Jan. 15, 2025

(51) Int. Cl. H04W 76/10; H04W 36/00

(52) U.S. Cl. CPC H04W 76/10; H04W 36/00692

(57) ABSTRACT

Technologies for self-establishment and management of a D2 interface in a cellular network are described. One method include extracting, by a first distributed unit (DU), secondary cells information from a message, wherein a user equipment (UE) is connected to a primary cell controlled by the first DU, and wherein the message is received from a centralized unit (CU); sending a request for transport network layer (TNL) information of a second DU based on the secondary cells information, wherein the UE is connected to a secondary cell controlled by the second DU; receiving the TNL information of the second DU; and establishing, by the first DU, a connection with the second DU.

### BACKGROUND

Cellular networks are highly complex. One type of cellular network is a fifth generation (5G) new radio (NR) cellular network. 5G NR cellular networks have the promise to provide higher throughput, lower latency, and higher availability compared with previous global wireless standards. The establishment and management of some interfaces in a 5G NR cellular network can be improved to facilitate such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing self-establishment and management of D2 interface in a cellular network according to at least one embodiment.

FIG. 2 is a block diagram of a system including D2 interface managers that implement self-establishment and management of D2 interface in a cellular network according to at least one embodiment.

FIGS. 3A and 3B are block diagrams of example D2 interfaces in a cellular network according to at least one embodiment.

FIGS. 4-7 illustrate example procedures of self-establishment and management of D2 interface according to at least one embodiment.

FIG. 8 illustrates an example data structure for management of D2 interface according to at least one embodiment.

FIG. 9 is a flow diagram of an example method of self-establishment of D2 interface in a cellular network according to at least one embodiment.

FIG. 10 is a flow diagram of an example method of management of D2 interface in a cellular network according to at least one embodiment.

### DETAILED DESCRIPTION

Technologies for self-establishment and management of D2 interfaces between neighbor open distributed units (O-DUs) in a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

The 5G NR cellular networks have limitations for multi-vendor deployment scenarios, and the open radio access network (O-RAN) is introduced to address some limitations. The O-RAN is a radio access network (RAN) system that allows interoperation between cellular network components provided by different vendors. The connection between O-DUs can be achieved through a D2 interface. The D2 interface can be defined to include a control part carrying control related information and a user plane part carrying user data. However, the discovery of neighbouring O-DUs and the establishment of D2 interface connections cannot be fully automated. Without the automated scheme, the operator would access every O-DU (or element management system (EMS)) and manually input information to associate the neighbouring O-DUs. The manual configuration process is not only tedious when dealing with a large amount of O-DUs but also impractical for instant updates, especially when the base station encounters an unexpected failure or the entire network reboots. In addition, managing D2 interface connections for every RAN configuration change is also cumbersome.

Aspects and embodiments of the present disclosure address the above and other deficiencies by providing a system that implements self-establishment and management of D2 interface connections in a cellular network. Specifically, a component of the cellular network (e.g., D2 interface manager) may be implemented into each of the base stations in the cellular network. The base station (e.g., “gNodeB” or “gNB”) refers to a network element responsible for the transmission and reception of radio signals in one or more cells (or coverage areas) to or from user equipment (UE). Each base station may include one or more radio units (RUs) and one or more distributed units (DUs),

Specifically, the D2 interface manager may extract information from messages received by the DU that controls the primary cell (PCell) of the UE (“PCell DU”). The primary cell (PCell) is the cell used to initiate initial access of the network by the UE. The extracted information may include a list of the secondary cells that are controlled by neighbor DUs (“candidate SCells DUs”), where these DUs support the carrier aggregation for the UE. The secondary cell (SCell) is the cell configured to work in conjunction with the PCell to provide additional capacity and coverage for the UE, and can be activated or deactivated according to the amount of data in the traffic. Carrier aggregation is a feature that enables the combination of multiple carriers in fragmented spectrum bands to increase peak user data rates and overall capacity of the network as well as to reduce the packet latency.

The D2 interface manager may use the extracted information to request the transport network layer (TNL) information (e.g., Internet Protocol (IP) address) of the candidate SCells DUs. The D2 interface manager may send the request of TNL information from the PCell DU to a centralized unit (CU) or a service management and orchestration (SMO)/element management system (EMS), and receive the TNL information accordingly. The procedure of requesting and receiving of TNL information can be described in various scenarios.

In one scenario that PCell DU and the candidate SCells DUs are connected with a same CU, the D2 interface manager may send, from the PCell DU to the CU, a “NEIGHBOR DU INFO REQUEST” message and receive, by the PCell DU from the CU, a “NEIGHBOR DU INFO RESPONSE” message that includes the TNL information.

In another scenario that PCell DU is connected with a first CU and the candidate SCells DUs are connected with a second CU, the D2 interface manager may send, from the PCell DU through the first CU to the second CU, a “NEIGHBOR DU INFO REQUEST” message and receive, by the PCell DU through the first CU from the second CU, a “NEIGHBOR DU INFO RESPONSE” message that includes the TNL information.

In yet another scenario that PCell DU and the candidate SCells DUs are managed by SMO/EMS, the D2 interface manager may send, from the PCell DU to the SMO/EMS, a “NETCONF get-config” message and receive, by the PCell DU from the SMO/EMS, a “NETCONF rpc-reply” message that includes the TNL information.

Once the D2 interface manager receives the TNL information of one SCell DU of the candidate SCells DUs (“target SCell DU”), the D2 interface manager may establish the connection between the PCell DU and the target SCell DU. The establishment of the D2 interface connection may involve sending a D2 connection setup request from the PCell DU to the target SCell DU and receiving a D2 connection setup response from the target SCell DU to the PCell DU. The same procedure for the establishment of the D2 interface connection can be applied to each of the candidate SCells DUs.

The D2 interface manager may maintain a data structure to store the list of candidate SCells and the related information, such as the TNL address of DU that manages SCell, the status of the D2 link, the latency of the D2 link, the cell load, the update timer, described below in detail.

Upon the establishment of the D2 interface connection between the PCell DU and the target SCell DU, the D2 interface manager may manage the connection by performing tests on the connection. The PCell DU may send the testing message (e.g., including timestamp) to target SCell DU periodically to check the link quality and readiness of the candidate SCells. The PCell DU may receive the testing response (e.g., including additional timestamp and cell load information) from the target SCell DU. The D2 interface manager may update information in the data structure based on the testing response (e.g., the status of the D2 link, the latency of the D2 link, the cell load). In some implementations, the DU, for example, via a radio scheduler in the DU, may select the SCells for carrier aggregation based on the information stored in the data structure, such as the status of the D2 link, the latency of the D2 link, the cell load, etc.

Aspects and embodiments of the present disclosure can find neighbor O-DUs that can cooperate to support carrier aggregation for a specific UE, setup D2 interface connection with the O-DUs, and manage the D2 interface connection in the cellular network. Aspects and embodiments of the present disclosure can use the information(e.g. latency, cell load) when O-DU decides on the candidate SCells for carrier aggregation. Aspects and embodiments of the present disclosure simplify network operation and maintenance by reducing human intervention, and enhance carrier aggregation performance by offering a mechanism to assess the cell load and link quality and availability.

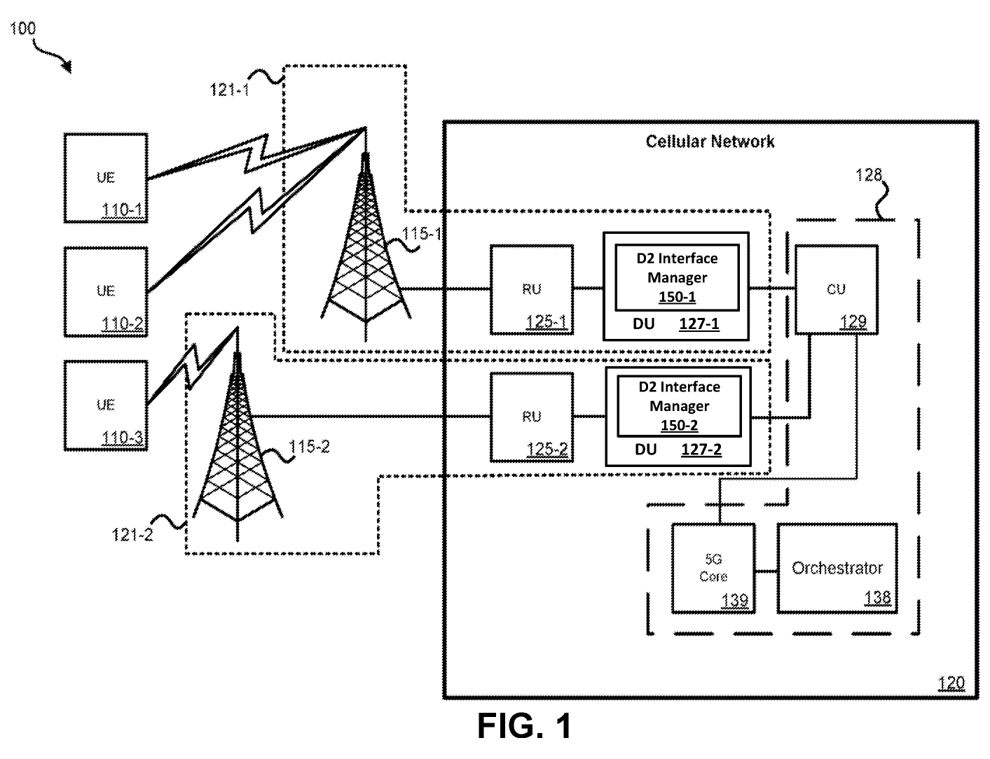

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

5G core 139 may reside on a cloud computing platform. While from a client’s or user’s point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

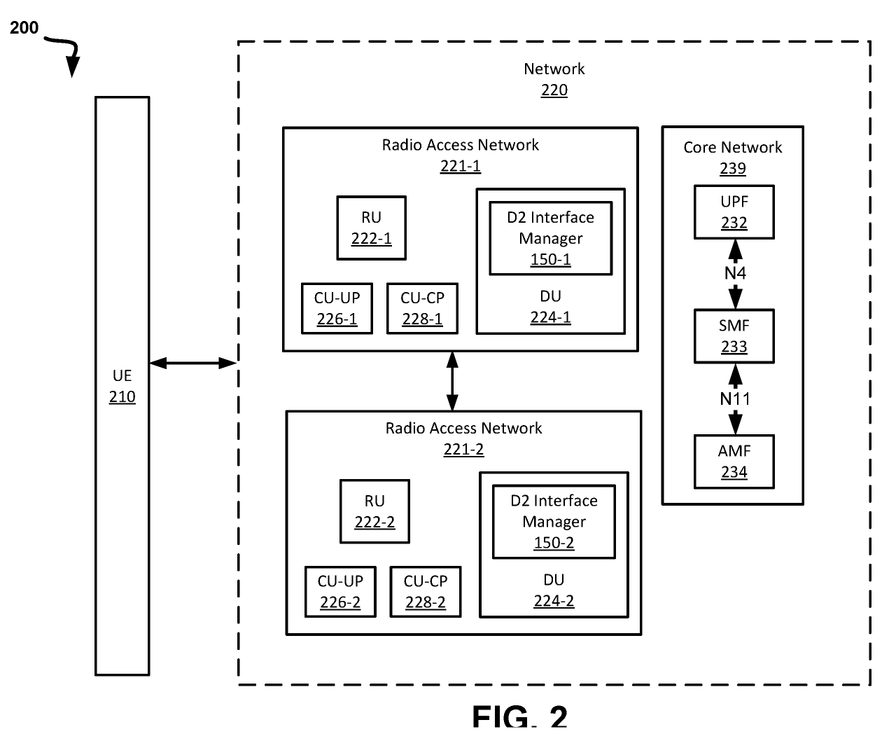

In some embodiments, each base station can include a D2 interface manager 150 to implement self-establishment and management of D2 interface in a cellular network. For example, the base station 121-1 includes a D2 interface manager 150-1 and the base station 121-2 includes a D2 interface manager 150-2. Further details regarding the operations of the D2 interface manager are described below with reference to FIGS. 2-10.

FIG. 2 is a block diagram of example D2 interface managers according to at least one embodiment. Referring to FIG. 2, a network 220 includes one or more radio access network (RAN) 221-1, 221-2, and one or more core network 239 according to at least one embodiment. The network 220 may include 4G network, 5G network, 6G network, etc. The network 220 connects user equipment (UE) 210 to the data network (not shown), and the data network can include the Internet, a local area network (LAN), a wide area network (WAN), a private data network, a wireless network, a wired network, or a combination of networks. The UE 210 can include an electronic device with wireless connectivity or cellular communication capability, such as a mobile phone or handheld computing device. In at least one example, the UE 210 can include a 5G smartphone or a 5G cellular device that connects to the RAN 221-1, 221-2 via a wireless connection. The UE 210 can include one of a number of UEs not depicted that are in communication with the RAN 221-1, 221-2. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221-1, 221-2.

The RAN 221-1 includes a radio unit (RU) 222-1 for wirelessly communicating with UE 210. The radio unit (RU) 222-1 may include one or more radio transceivers for wirelessly communicating with UE 210. The radio unit (RU) 222-1 may include circuitry for converting signals sent to and from an antenna of a Base Station into digital signals for transmission over packet networks. In some implementations, the RAN 221-1 may correspond with a 5G radio Base Station that connects user equipment to the core network 239. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210.

The RAN 221-1 can include a new-generation radio access network (NG-RAN) that uses the 5G NR interface. In some embodiments, the distributed unit (DU) 224-1 and the centralized unit (CU) of the RAN 221-1 may be co-located with the RU 222-1. In other embodiments, the DU 224-1 and the RU 222-1 may be co-located at a cell site and the centralized unit (CU) may be located within a local data center (LDC). The DU 224-1 can include a logical node configured to provide functions for the radio link control (RLC) layer, the medium access control (MAC) layer, and the physical layer (PHY) layers. The centralized unit (CU) can be partitioned into a CU user plane portion (CU-UP) 226-1 and a CU control plane portion (CU-CP) 228-1. The CU-CP 228-1 may perform functions related to a control plane, such as connection setup, mobility, and security. The CU-UP 226-1 may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) 228-1 can include a logical node configured to provide functions of the control plane part of the RRC and PDCP. The centralized unit for the user plane(CU-UP) 226-1 can include a logical node configured to provide functions of the user plane part of the SDAP and PDCP. In some embodiments, the RAN 221-1 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221-1 may include a set of one or more remote radio units (RUs) that includes radio transceivers (or combinations of radio transmitters and receivers) for wirelessly communicating with UEs. The set of RUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RU).

In some cases, the UE 210 may be capable of transmitting signals to and receiving signals from one or more RUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transmit and receive radio signals using multiple-input multiple-output (MIMO) antennas that may be connected to a cell tower, an antenna mast, or a raised structure.

The core network 239 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF) 234, the session management function (SMF) 233, and the user plane function (UPF) 232. The AMF 334 may interface with UE 210, act as a single-entry point for a UE connection, and perform mobility management, registration management, and connection management between data network and UE 210. The AMF 234 may interface with the SMF 233 to track user sessions. The AMF 234 may interface with a network slice selection function (NSSF) to select network slice instances for user equipment. When user equipment is leaving a first coverage area and entering a second coverage area, the AMF 234 may be responsible for coordinating the handoff between the coverage areas whether the coverage areas are associated with the same radio access network or different radio access networks. The SMF 233 may perform session management, user plane selection, and Internet Protocol (IP) address allocation. After the Access Gateway Function (AGF) authenticates the subscriber and establishes a protocol data unit (PDU) session, the SMF 233 may select the UPF for the subscriber.

The UPF 232 may provide subscriber tunnel encapsulations enabled by the general packet radio service (GPRS) tunneling protocol, packet processing including routing and forwarding, quality of service (QoS) handling, packet data unit (PDU) session management, policy enforcement, statistics gathering and reporting, lawful intercept requests processing, and optional advanced services. The UPF 232 may serve as an ingress and egress point for user plane traffic and provide anchored mobility support for user equipment. The UPF 232 may be implemented as a software process or application running within a virtualized infrastructure or a cloud-based compute and storage infrastructure.

The UPF 232 may transfer downlink data received from the data network to the UE 210, via the RAN 221-1 and/or transfer uplink data received from the UE 210 to the data network via the RAN 221-1. An uplink can include a radio link through which UE 210 transmits data and/or control signals to the RAN 221-1. A downlink can include a radio link through which the RAN 221-1 transmits data and/or control signals to the UE 210.

Uplink packets arriving from the RAN 221-1 may use a general packet radio service (GPRS) tunneling protocol (or GTP) to reach the UPF 232. The GPRS tunneling protocol for the user plane may support multiplexing of traffic from different PDU sessions by tunneling user data over the interface N3 between the RAN 221-1 and the UPF 232. The UPF 232 may remove the packet headers belonging to the GTP tunnel before forwarding the user plane packets towards the data network. As the UPF 232 may provide connectivity towards other data networks in addition to the data network, the UPF 232 ensures that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF 232 may keep a record of the mapping between the GTP tunnel, the PDU session, and the DNN for the data network to which the user plane packets are directed.

Downlink packets arriving from the data network are mapped onto a specific quality of service (QoS) flow belonging to a specific PDU session before forwarded towards the appropriate RAN 221-1. A QoS flow may correspond with a stream of data packets that have equal QoS. The PDU session may utilize one or more QoS flows to exchange traffic (e.g., data and voice traffic) between the UE 210 and the data network. The one or more QoS flows can include the finest granularity of QoS differentiation within the PDU session. The PDU session may belong to a network slice instance through the network 220. To establish user plane connectivity from the UE 210 to the data network, the AMF 234 that supports the network slice instance may be selected and a PDU session via the network slice instance may be established. In some cases, the PDU session may be of type IPv4 or IPv6 for transporting IP packets. The RAN 221-1 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when the UE 210 requests access to resources, such as establishing a PDU session or a QoS flow, the PCF may dynamically decide if the UE 210 should grant the requested access based on a location of the UE 210.

The network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a network, such as an instantiation of the network 220. In some cases, the network 220 may support customized policy configuration and enforcement between network slices per service level agreements (SLAs) within the radio access network (RAN) 221-1. User equipment, such as UE 210, may connect to multiple network slices at the same time (e.g., eight different network slices). In some cases, the network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64GB virtual disk) for the virtual machine. Another example of a virtualized component is a software container or an application container that encapsulates an application’s environment. In some embodiments, applications and services may be run using virtual machines instead of containers in order to improve security. A common virtual machine may also be used to run applications and/or containers for a number of closely related network services.

The network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

RAN 221-2 may be similar to RAN 221-1 as described above. In some implementations, RAN 221-1 includes a D2 interface manager 150-1 and RAN 221-2 includes a D2 interface manager 150-2. In some implementations, DU 224-1 includes a D2 interface manager 150-1 and DU 224-2 includes a D2 interface manager 150-2. Specifically, the D2 interface manager 150-1, 150-2 may extract information from messages received by PCell DU, use the extracted information to request the TNL information (e.g., IP address) of the candidate SCells DUs. The D2 interface manager 150-1, 150-2 may send the request of TNL information from the PCell DU to a CU or a SMO/EMS, and receive the TNL information accordingly. Once the D2 interface manager 150-1, 150-2 receives the TNL information of one SCell DU of the candidate SCells DUs (“target SCell DU”), the D2 interface manager 150-1, 150-2 may establish the connection between the PCell DU and the target SCell DU. The D2 interface manager 150-1, 150-2 may maintain a data structure to store the list of candidate SCells and the related information, such as the TNL address of DU that manages SCell, the status of the D2 link, the latency of the D2 link, the cell load, the update timer, described below. Upon the establishment of the D2 interface connection between the PCell DU and the target SCell DU, the D2 interface manager 150-1, 150-2 may manage the connection by performing tests on the connection and update information in the data structure based on the testing response (e.g., the status of the D2 link, the latency of the D2 link, the cell load).

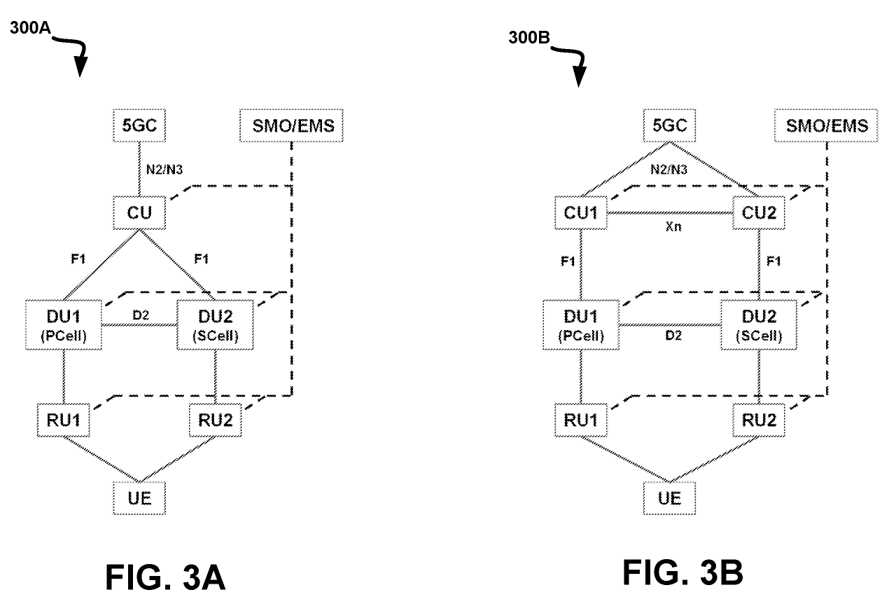

FIGS. 3A and 3B illustrate example scenarios of establishing D2 interface connection in a cellular network according to at least one embodiment. FIG. 3A illustrates an “intra-CU” scenario that two DUs are connected with the same CU, while FIG. 3B illustrates an “inter-CU” scenario that two DUs are connected with different CUs. As shown in FIGS. 3A and 3B, two DUs (i.e., DU1 and DU2) are illustrated and used by the UE. DU1 may control a primary cell (PCell), which is the cell used to initiate initial access of the network by the UE. DU2 may control a secondary cell (SCell), with which the UE is configured to work in conjunction with the PCell to provide additional capacity and coverage, and can be activated or deactivated according to the amount of data in the traffic.

Referring to FIG. 3A, UE is connected with RUs (i.e., RU1 and RU2), RU1 is connected with DU1, and RU2 is connected with DU2. DU1 is connected with CU via F1 interface, and DU2 is connected with CU via F1 interface. CU is connected with the 5G core network (5GC) via the N2/N3 interface. DU1 and DU2 are connected via D2 interface.

Referring to FIG. 3B, UE is connected with RUs (i.e., RU1 and RU2), RU1 is connected with DU1, and RU2 is connected with DU2. DU1 is connected with CU1 via F1 interface, and DU2 is connected with CU2 via F1 interface. CU1 and CU2 each is connected with the 5G core network (5GC) via the N2/N3 interface. DU1 and DU2 are connected via D2 interface.

Service management and orchestration (SMO) may configure one or more O-DUs using O1 interface as shown in FIGS. 3A and 3B. SMO may include element management system (EMS) that manages network elements, where the network element is a manageable logical entity uniting one or more physical devices. The network functions (NFs) from various vendors can be managed by SMO/EMS from one or multiple vendors. SMO/EMS can manage the interface between O-DUs. The existing O1 interface between SMO and O-DU can be extended to bring in the configuration for functioning of the D2 interface.

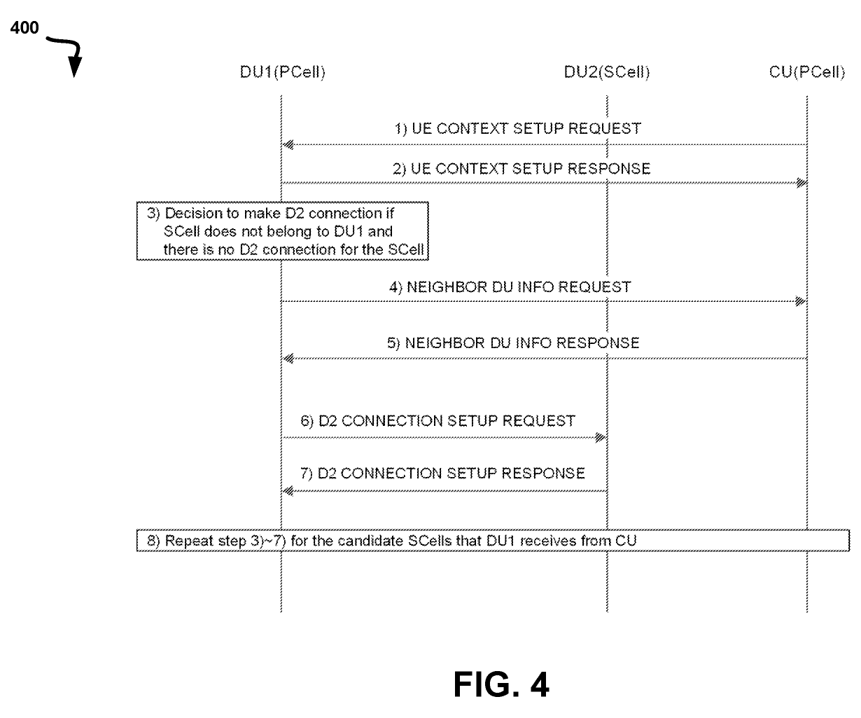

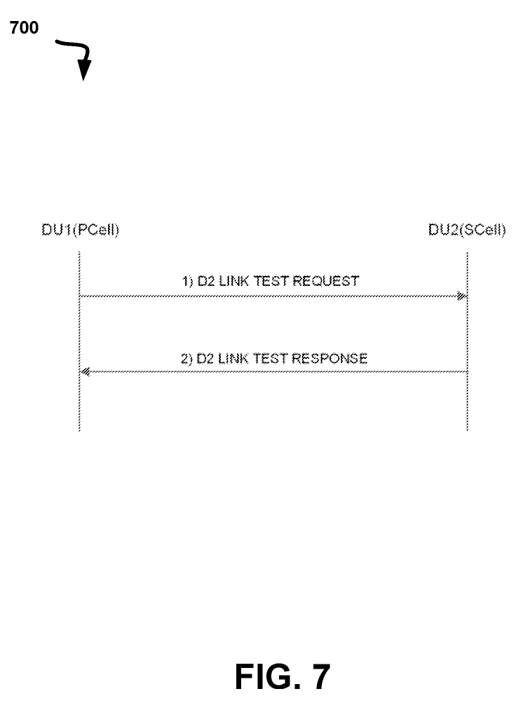

FIGS. 4-7 illustrate example procedures of self-establishment and management of D2 interface according to at least one embodiment. FIGS. 4-6 illustrate example procedures of self-establishment of D2 interface under various scenarios. FIG. 7 illustrates example procedure of management of D2 interface connection.

FIG. 4 illustrates a procedure 400 of self-establishment of D2 interface in the scenario that two DUs are connected to the same CU. At step 1, CU sends, to DU1, “UE CONTEXT SETUP REQUEST” message, requesting to make a UE associated connection between DU1 and CU, where the UE is connected to the primary cell (PCell) controlled by DU1. The message is transmitted over F1 interface. The message contains “SCell To Be Setup List IE” information to provide candidate secondary cells (SCells) information to DU1 for carrier aggregation of the UE. At step 2, DU1 responds with “UE CONTEXT SETUP RESPONSE” message to CU. For example, “UE CONTEXT SETUP RESPONSE” message may include the result for the requested data radio bearers (DRBs), signaling radio bearers (SRBs), backhaul radio link control (BH RLC) channels, Uu relay radio link control (RLC) channels, PC5 relay RLC channels, and sidelink (SL) DRBs configuration. At step 3, DU1 checks whether the SCell belongs to DU1 or not. If the SCell does not belong to DU1 and there is no D2 interface connection for the SCell, DU1 determines to setup a D2 interface connection. At step 4, in order to setup a D2 interface connection, DU1 requests for transport network layer (TNL) information by sending “NEIGHBOR DU INFO REQUEST” message to CU. The message includes the SCell information. At step 5, in response, by sending “NEIGHBOR DU INFO RESPONSE” message to DU1, CU provides TNL information (such as IP address) of the neighbor DU that the SCell belongs to. At step 6, based on the TNL information, DU1 sends “D2 CONNECTION SETUP REQUEST” message to DU2. At step 7, in response, DU2 sends “D2 CONNECTION SETUP RESPONSE” message to DU1, which represents the completion of the establishment of D2 interface connection between DU1 and DU2. At step 8, DU1 repeats steps 3 to 7 for the candidate SCells that DU1 receives from CU. In steps 4 and 5, DU1 may request the TNL information for all candidate SCells that do not belong to DU1 by listing them in the same message.

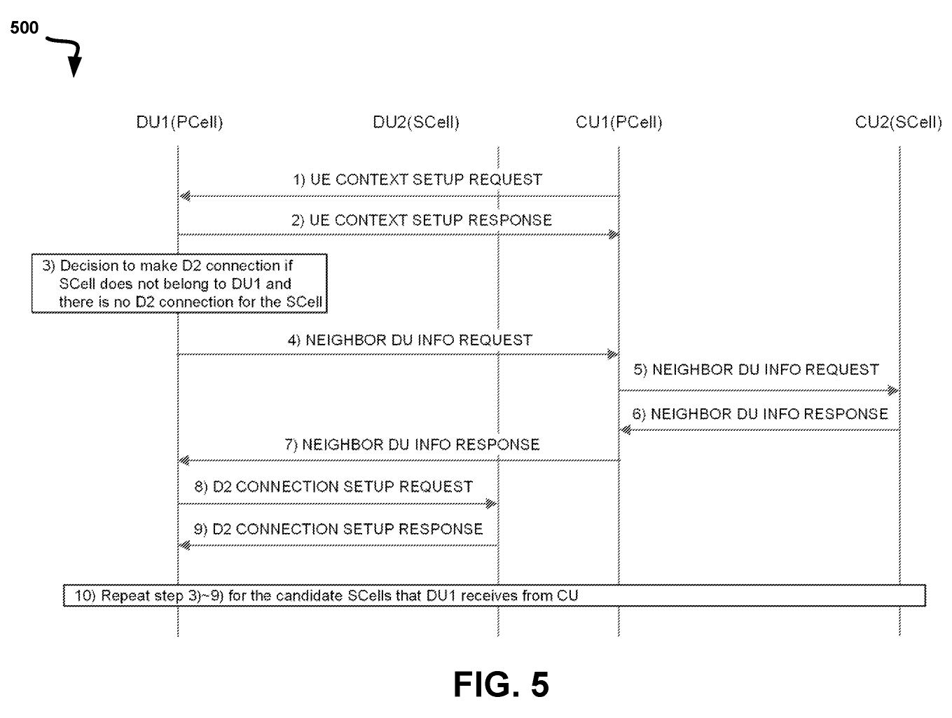

FIG. 5 illustrates a procedure 500 of self-establishment of D2 interface in the scenario that two DUs are connected to different CUs. At step 1, CU1 sends, to DU1, “UE CONTEXT SETUP REQUEST” message, requesting to make a UE associated connection between DU1 and CU1, where the UE is connected to the primary cell (PCell) controlled by DU1. The message contains “SCell To Be Setup List IE” information to provide candidate SCells information to DU1 for carrier aggregation of the UE. At step 2, DU1 responds with “UE CONTEXT SETUP RESPONSE” message to CU1. At step 3, DU1 checks whether the SCell belongs to DU1 or not. If the SCell does not belong to DU1 and there is no D2 interface connection for the SCell, DU1 determines to setup a D2 interface connection. At step 4, in order to setup a D2 interface connection, DU1 requests for TNL information by sending “NEIGHBOR DU INFO REQUEST” message to CU1. The message includes the SCell information. At step 5, CU1 finds a neighbor CU that manages the SCell and requests TNL information of the DU that controls the SCell. At step 6, in response, CU2 sends, to CU1, “NEIGHBOR DU INFO RESPONSE” message that contains the TNL information of DU2. At step 7, CU1 forwards the same information to DU1 by using “NEIGHBOR DU INFO RESPONSE” message. At step 8, based on the TNL information, DU1 sends a “D2 CONNECTION SETUP REQUEST” message to DU2. At step 9, in response, DU2 sends “D2 CONNECTION SETUP RESPONSE” message to DU1, which represents the completion of the establishment of D2 interface connection between DU1 and DU2. At step 10, DU1 repeats steps 3 to 9 for the candidate SCells that DU1 receives from CU1. In step 4, DU1 can request the TNL information for all candidate SCells that do not belong to DU1 by listing them in the same message.

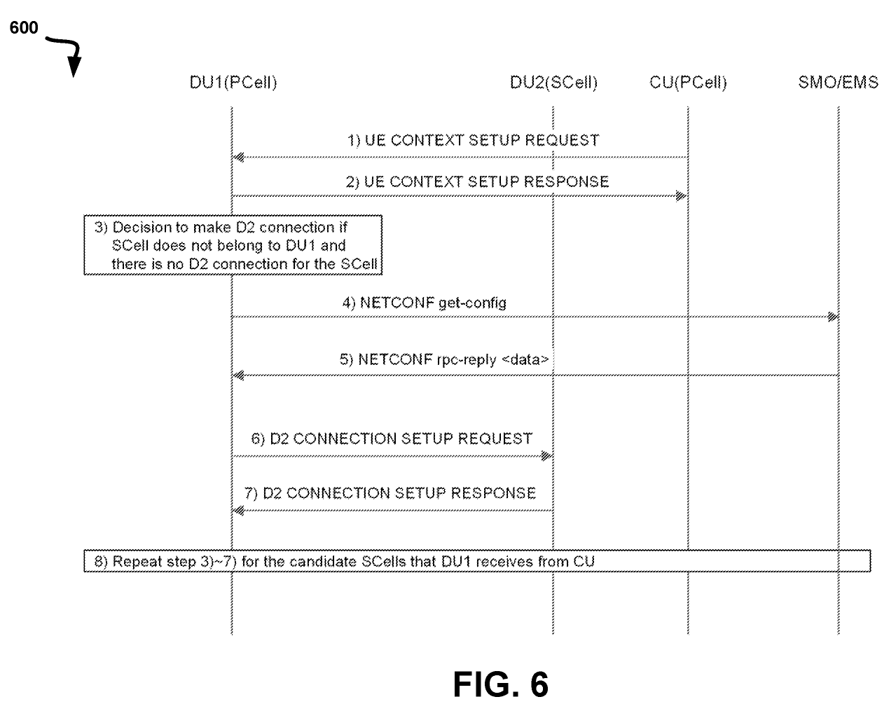

FIG. 6 illustrates a procedure 600 of self-establishment of D2 interface in the scenario that SMO/EMS manages, through O1 interface, two DUs that are connected to same or different CUs. At step 1, CU sends, to DU1, “UE CONTEXT SETUP REQUEST” message, requesting to make a UE associated connection between DU1 and CU, where the UE is connected to the primary cell (PCell) controlled by DU1. The message is transmitted over F1 interface. The message contains “SCell To Be Setup List IE” information to provide candidate SCells information to DU1 for carrier aggregation of the UE. At step 2, DU1 responds with “UE CONTEXT SETUP RESPONSE” message to CU. At step 3, DU1 checks whether the SCell belongs to DU1 or not. If the SCell does not belong to DU1 and there is no D2 interface connection for the SCell, DU1 determines to setup a D2 interface connection. At step 4, in order to setup D2 interface connection, DU1 requests for TNL information by sending “NETCONF get-config” message to SMO/EMS via O1 interface. The message includes the SCell information. At step 5, in response, by sending “NETCONF rpc-reply” message to DU1 via O1 interface, SMO/EMS provides TNL information of the neighbor DU that the SCell belongs to. At step 6, based on the TNL information, DU1 sends “D2 CONNECTION SETUP REQUEST message” to DU2. At step 7, in response, DU2 sends “D2 CONNECTION SETUP RESPONSE” message to DU1, which represents the completion of the establishment of D2 interface connection between DU1 and DU2. At step 8, DU1 repeats steps 3 to 7 for the candidate SCells that DU1 receives from CU. In steps 4 and 5, DU1 may request the TNL information for all candidate SCells that do not belong to DU1 by listing them in the same message. For D2 interface configuration and management, existing O1 interface that brings O-DU configuration from SMO can be enhanced.

FIG. 7 illustrates a procedure 700 of management of D2 interface. At step 1, DU1 sends “D2 LINK TEST REQUEST” message to DU2 periodically in order to check the link quality and readiness of the candidate SCells. DU1 puts a timestamp in the message. The message also includes a list of SCells that DU1 is trying to use if the neighbor DU (DU2) manages multiple SCells that can be associated with the DU1. At step 2, upon receiving “D2 LINK TEST REQUEST” message, DU2 responds with “D2 LINK TEST RESPONSE” message to DU1. The DU2 copies the timestamp it received into the response message and additionally puts a new timestamp it generates, so that DU1 and DU2 can measure the delay in each direction of the communication. DU2 may also put the cell load information in the response message for each requested SCell. The cell load is calculated as the ratio of the number of PRBs available to the total number of PRBs of the carrier for a certain period of time. If DU2 does not want to participate in the carrier aggregation with the requested SCell, DU2 may send the value “0%” for the cell load information.

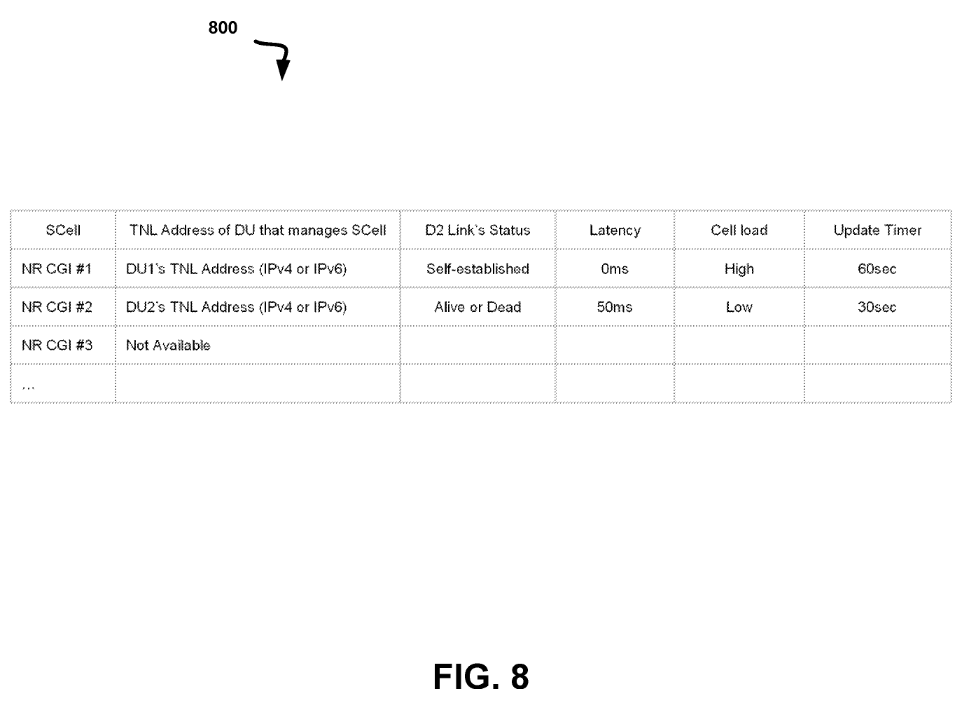

FIG. 8 illustrates an example data structure for management of D2 interface according to at least one embodiment. DU (e.g., DU1) may maintain a data structure (e.g., a table) to record the associated parameters. As shown in the data structure 800, the parameters may include a list of candidate SCells, the TNL address of DU that manages SCell, the status of the D2 link, the latency of the D2 link, the cell load, the update timer, etc. The TNL address of DU can be an IP address and may be acquired by various methods from SMO/EMS or CU as shown in FIG. 4-6. The status of D2 link status can be “self-established,” “alive,” or “dead.” The cell load can be a value or can be “high” or “low.” The update timer can be a pre-configured time period to trigger the DU to send a “D2 link test request” message to the neighbor DU when it expires.

Responsive to receiving the candidate SCell information from CU as shown in FIGS. 4-6, DU may add these SCell information in the data structure. Once a D2 link is set up, the DU will periodically communicate with the neighbor DU as illustrated with respect to FIG. 7, and the DU may update the data structure with the latest information of the above-described parameters. In one example, if the DU fails to receive any response message from the neighbor DU during a pre-configured time period, DU may change the status of the D2 link from “alive” to “dead” and DU may try to ping the neighbor DU every pre-configured time period specified in “update timer.”

When the DU determines to activate a SCell for carrier aggregation, it checks the information stored in the data structure. For example, if the latency is longer than a threshold time period, DU does not select the SCell for carrier aggregation. As another example, if the cell load is greater than a threshold load, DU does not select the SCell for carrier aggregation. As yet another example, the DU does not select the SCell that is over the “dead” D2 link.

In some implementations, a system (e.g., system 100 in FIG. 1, or system 200 in FIG. 2) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a D2 interface manager (e.g., the D2 interface manager of FIGS. 1-2).

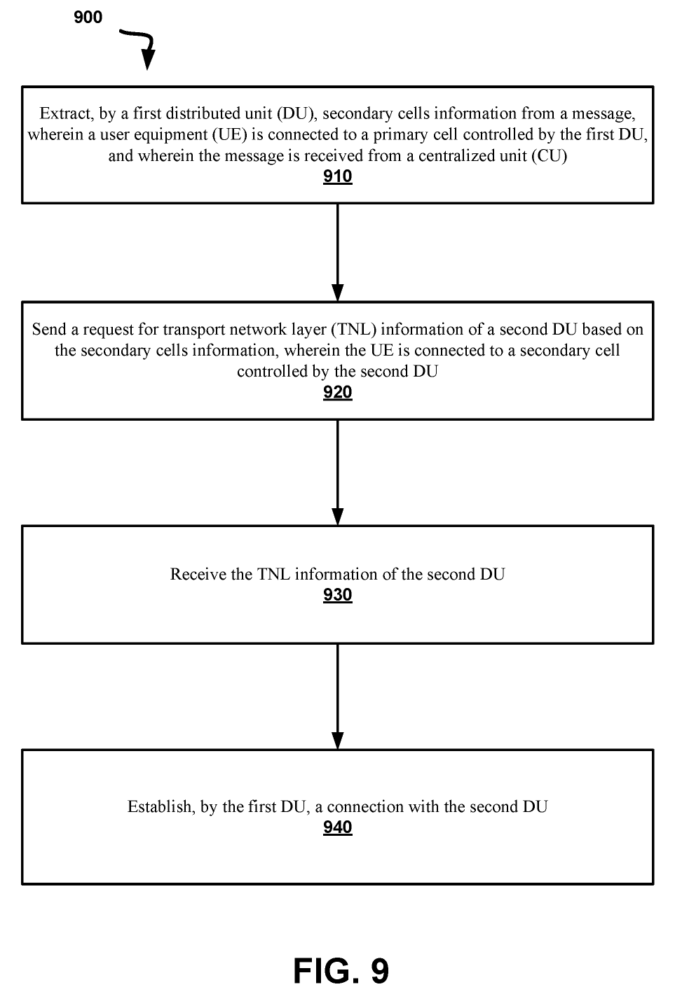

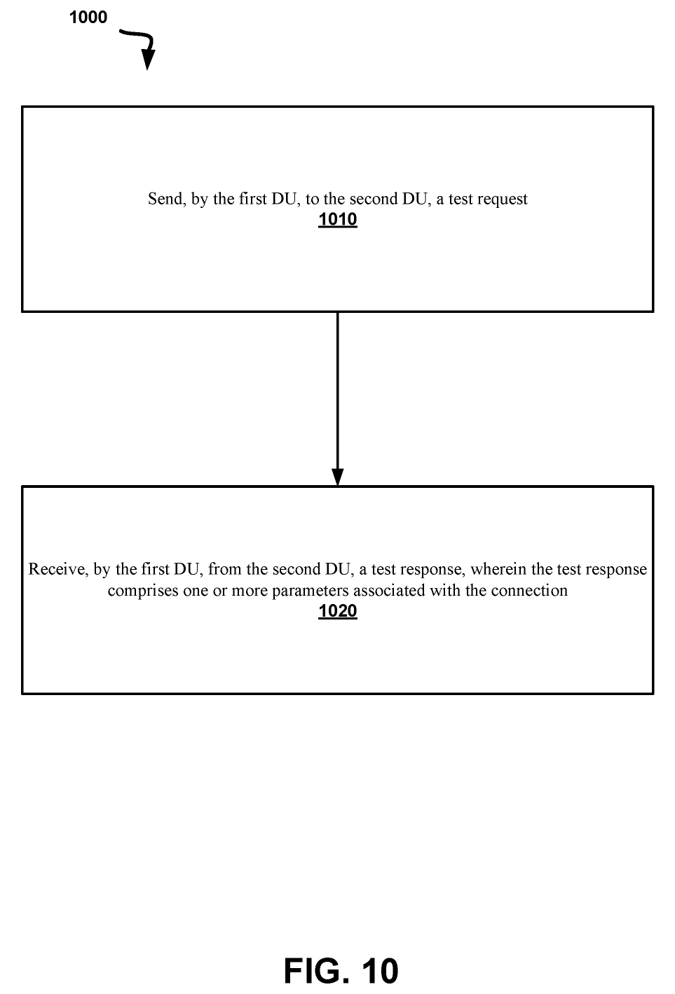

FIGS. 9 and 10 are flow diagrams of methods 900 and 1000 of self-establishment and management of D2 interface in a cellular network according to at least one embodiment. The methods 900 and 1000 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 900 and 1000 are performed by the system 100 of FIG. 1. In one embodiment, the methods 900 and 1000 are performed by the D2 interface manager 150-1, 150-2, of FIGS. 1-2.

Referring to FIG. 9, at operation 910, the processing device may extract, by a first DU, secondary cells information from a message, wherein UE is connected to a primary cell controlled by the first DU, and wherein the message is received from a CU.

In some implementations, the first DU is an O-DU. In some implementations, the O-DU extracts candidate SCells information from F1 interface-Application Protocol (F1-AP) messages. In some implementations, the F1-AP messages comprise “UE CONTEXT SETUP REQUEST” or “UE CONTEXT MODIFICATION REQUEST” message. In some implementations, using the F1-AP messages, O-CU informs O-DU of the list of candidate SCells to support carrier aggregation for the UE . In some implementations, the O-DU determines whether the candidate SCell belongs to itself or not. In some implementations, responsive to determining that the candidate SCell does not belong to itself, the O-DU sends a request to the O-CU or EMS to get the IP address of the neighbor O-DU that controls the SCell.

At operation 920, the processing device may send a request for transport network layer (TNL) information of a second DU based on the secondary cells information, wherein the UE is connected to a secondary cell controlled by the second DU. At operation 930, the processing device may receive the TNL information of the second DU. In some implementations, the first DU and the second DU are connected to the CU, wherein the request is sent to the CU, and wherein the TNL information of the second DU is received from the CU. In some implementations, the first DU is connected to the CU and the second DU is connected to a second CU, wherein the request is sent to the second CU via the CU, and wherein the TNL information of the second DU is received from the second CU via the CU. In some implementations, the first DU and the second DU are managed by a service management and orchestration (SMO) or an element management system (EMS), wherein the request is sent to the SMO or the EMS, and wherein the TNL information of the second DU is received from the SMO or the EMS.

In some implementations, once the O-DU extracts candidate SCells information from F1-AP messages, manual configuration on O-DU is used to get the TNL addresses of the O-DUs that control the SCells. In some implementations, the manual configuration on O-DU involves directly accessing the O-DU and configuring a table (e.g., data structure 800) that record associated information (e.g., SCell and its O-DU TNL address (e.g. IP address)).

In some implementations, once the O-DU extracts candidate SCells information from F1-AP messages, manual configuration on EMS is used to get the TNL addresses of the O-DUs that control the SCells. In some implementations, the manual configuration on EMS involves directly accessing EMS (part of SMO, or configuration server) and configuring the associated information (e.g., SCell and its O-DU TNL address). In some implementations, the EMS provides the information when O-DU queries.

In some implementations, once the O-DU extracts candidate SCells information from F1-AP messages, self-acquisition from O-CU is used to get the TNL addresses of the O-DUs that control the SCells. In some implementations, the self-acquisition from O-CU involves O-DU asking O-CU for the TNL address of a neighbor O-DU that controls the SCell by sending a “NEIGHBOR DU INFO REQUEST” massage (e.g., contains a candidate SCell information).

In some implementations, once the O-DU extracts candidate SCells information from F1-AP messages, self-acquisition from EMS is used to get the TNL addresses of the O-DUs that control the SCells. In some implementations, the self-acquisition from EMS involves O-DU asking EMS for the TNL address of a neighbor O-DU that controls the SCell by sending a “NEIGHBOR DU INFO REQUEST” massage (e.g., contains a candidate SCell information).

At operation 940, the processing device may establish, by the first DU, a connection with the second DU. In some implementations, the processing device may maintain a data structure recording a plurality of parameters associated with one or more secondary cells that are included in the secondary cells information. In some implementations, the plurality of parameters comprise at least one of: a status of a D2 link, a latency of the D2 link, a cell load, or an update timer. In some implementations, the processing device may select one or more secondary cells for carrier aggregation based on the plurality of parameters.

Referring to FIG. 10, at operation 1010, the processing device may send, by the first DU, to the second DU, a test request. At operation 1020, the processing device may receive, by the first DU, from the second DU, a test response, wherein the test response comprises one or more parameters associated with the connection.

In some implementations, once O-DU establishes a D2 interface connection with a neighbor O-DU, O-DU periodically checks the availability of the link by pinging the neighbor O-DU and measures the latency to the neighbor O-DU and gets the load information of the SCell. In some implementations, “D2 Link Test Request and Response” messages are used by O-DU to select a quality candidate SCells for carrier aggregation for the UE. In some implementations, periodic exchange of “D2 Link Test Request and Response” messages is used to check the availability of the neighbor O-DU. In some implementations, in order to measure the latency in each direction of the D2 link, a timestamp is put in the “D2 Link Test Request” message by the sender and in the “D2 Link Test Response” message by the responder. In some implementations, O-DUs are all synchronized using Precision Time Protocol (PTP) and Global Positioning System (GPS), which enables the O-DU to calculate the latency in each direction. In some implementations, the neighbor O-DU puts the load information of the SCell in the “D2 Link Test Response” message, which may help the O-DU decide when activating the SCell.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of self-establishment and management of a D2 interface in a cellular network, the method comprising:
extracting, by a first distributed unit (DU), secondary cells information from a message, wherein a user equipment (UE) is connected to a primary cell controlled by the first DU, and wherein the message is received from a centralized unit (CU);
sending a request for transport network layer (TNL) information of a second DU based on the secondary cells information, wherein the UE is connected to a secondary cell controlled by the second DU;
receiving the TNL information of the second DU; and
establishing, by the first DU, a connection with the second DU.

2. The method of claim 1, further comprising:
sending, by the first DU, to the second DU, a test request; and
receiving, by the first DU, from the second DU, a test response, wherein the test response comprises one or more parameters associated with the connection.

3. The method of claim 1, further comprising:
maintaining a data structure recording a plurality of parameters associated with one or more secondary cells that are included in the secondary cells information.

4. The method of claim 3, wherein the plurality of parameters comprise at least one of: a status of a D2 link, a latency of the D2 link, a cell load, or an update timer.

5. The method of claim 3, further comprising:
selecting one or more secondary cells for carrier aggregation based on the plurality of parameters.

6. The method of claim 1, wherein the first DU and the second DU are connected to the CU, wherein the request is sent to the CU, and wherein the TNL information of the second DU is received from the CU.

7. The method of claim 1, wherein the first DU is connected to the CU and the second DU is connected to a second CU, wherein the request is sent to the second CU via the CU, and wherein the TNL information of the second DU is received from the second CU via the CU.

8. The method of claim 1, wherein the first DU and the second DU are managed by a service management and orchestration (SMO) or an element management system (EMS), wherein the request is sent to the SMO or the EMS, and wherein the TNL information of the second DU is received from the SMO or the EMS.

9. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
extracting, by a first distributed unit (DU), secondary cells information from a message, wherein a user equipment (UE) is connected to a primary cell controlled by the first DU, and wherein the message is received from a centralized unit (CU);
sending a request for transport network layer (TNL) information of a second DU based on the secondary cells information, wherein the UE is connected to a secondary cell controlled by the second DU;
receiving the TNL information of the second DU; and
establishing, by the first DU, a connection with the second DU.

10. The computing system of claim 9, wherein the operations further comprise:
sending, by the first DU, to the second DU, a test request; and
receiving, by the first DU, from the second DU, a test response, wherein the test response comprises one or more parameters associated with the connection.

11. The computing system of claim 9, wherein the operations further comprise:
maintaining a data structure recording a plurality of parameters associated with one or more secondary cells that are included in the secondary cells information.

12. The computing system of claim 11, wherein the plurality of parameters comprise at least one of: a status of a D2 link, a latency of the D2 link, a cell load, or an update timer.

13. The computing system of claim 11, wherein the operations further comprise:
selecting one or more secondary cells for carrier aggregation based on the plurality of parameters.

14. The computing system of claim 9, wherein the first DU and the second DU are connected to the CU, wherein the request is sent to the CU, and wherein the TNL information of the second DU is received from the CU.

15. The computing system of claim 9, wherein the first DU is connected to the CU and the second DU is connected to a second CU, wherein the request is sent to the second CU via the CU, and wherein the TNL information of the second DU is received from the second CU via the CU.

16. The computing system of claim 9, wherein the first DU and the second DU are managed by a service management and orchestration (SMO) or an element management system (EMS), wherein the request is sent to the SMO or the EMS, and wherein the TNL information of the second DU is received from the SMO or the EMS.

17. One or more non-transitory, computer-readable storage media having computer-readable instructions thereon which, when executed by one or more processing devices, cause the one or more processing devices to perform operations comprising:
extracting, by a first distributed unit (DU), secondary cells information from a message, wherein a user equipment (UE) is connected to a primary cell controlled by the first DU, and wherein the message is received from a centralized unit (CU);
sending a request for transport network layer (TNL) information of a second DU based on the secondary cells information, wherein the UE is connected to a secondary cell controlled by the second DU;
receiving the TNL information of the second DU; and
establishing, by the first DU, a connection with the second DU.

18. The one or more non-transitory, computer-readable storage media of claim 17, wherein the operations further comprise:
sending, by the first DU, to the second DU, a test request; and
receiving, by the first DU, from the second DU, a test response, wherein the test response comprises one or more parameters associated with the connection.

19. The one or more non-transitory, computer-readable storage media of claim 17, wherein the operations further comprise:
maintaining a data structure recording a plurality of parameters associated with one or more secondary cells that are included in the secondary cells information.

20. The one or more non-transitory, computer-readable storage media of claim 19, wherein the plurality of parameters comprise at least one of: a status of a D2 link, a latency of the D2 link, a cell load, or an update timer.
